(19) United States
(12) Patent Application Publication
(10) Pub. No.: US 2009/0034834 A1
(43) Pub. Date: Feb. 5, 2009

(54) System and method for image processing

(75) Inventors: Richard Mark Friedhoff, New York, NY (US); Casey Arthur Smith, Ithaca, NY (US); Bruce Allen Maxwell, Springfield, PA (US)

Correspondence Address: Davidson, Davidson & Kappel, LLC, 485 7th Avenue, 14th Floor, New York, NY, 10018, US

(73) Assignee: Tandent Vision Science, Inc., San Francisco, CA (US)

(21) Appl. No.: 11/888,486

(22) Filed: Aug. 1, 2007

(51) Int. Cl. G06K 9/00

(52) U.S. Cl. 382/162

(57) ABSTRACT

In a first exemplary embodiment of the present invention, an automated, computerized method is provided for processing an image. According to a feature of the present invention, the method comprises the steps of generating a gradient representation of the image, and normalizing the gradient representation to generate an illumination-invariant gradient representation of the image.

### BACKGROUND OF THE INVENTION

Computer learning techniques have been implemented in computer systems, and effectively used in an analysis and processing of images, to, for example, identify objects of interest to a user. Learning frameworks provide a method for computers to discover important characteristics or features of a selected object, such as, for example, a human face. In some known learning frameworks, the features used by the system are preselected by the user, and the framework learns the relative utility, useful ranges, or relationships between the features that can then be used by the computer system to identify the selected objects of interest that may appear in an image. In other known systems, a large set of features is evaluated by the learning framework, for identification of particular features that are important to an object identification task.

Commercially available image capturing devices, such as, for example, digital cameras, typically record and store images in a series of pixels. Each pixel comprises digital values corresponding to a set of color bands, for example, most commonly, red, green and blue color components (RGB) of the picture element. While the RGB representation of a scene recorded in an image is acceptable for viewing the image in an aesthetically pleasing color depiction, the red, green and blue band depiction may not be optimal for computer processing of the recorded image for purposes of such applications as, for example, object recognition.

Gradients are often utilized to provide a more suitable representation of an image for purposes of computer processing. A gradient is a measure of the magnitude and direction of color and/or color intensity change within an image, as for example across edges caused by features of objects depicted in the image. A set of gradients corresponding to an object describes the appearance of the object, and therefore features generated from gradients can be utilized in a computer processing of an image to concisely represent significant and identifying attributes of the object.

A significant problem associated with gradient processing is that illumination conditions can vary greatly from image to image, causing, for example, varying shadow conditions in the images that effect gradient values, including the presence of extra illumination related gradients and variations of the values of material gradients. Moreover, the exposure time of a camera used to record an image, and the spectra and/or intensity of the light present at the time the image was recorded can vary. Thus, a certain object for which a computer analysis is desired for identification of the object as it may appear in a set of images, can appear differently in the gradient representations of the various images, as a function of the illumination conditions at the time the various images were recorded. The different appearances can effect an accurate identification of the object of interest via the computer processing.

### SUMMARY OF THE INVENTION

The present invention provides a method and system for improving computer processing of images for such tasks as, for example, object recognition, through the implementation and integration of methods and systems to optimize an image for enhanced performance of computer-related processing of the image.

In a first exemplary embodiment of the present invention, an automated, computerized method is provided for processing an image. According to a feature of the present invention, the method comprises the steps of generating a gradient representation of the image, and normalizing the gradient representation to generate an illumination-invariant gradient representation of the image.

In a second exemplary embodiment of the present invention, an automated, computerized method is provided for processing an image. According to a feature of the present invention, the method comprises the steps of generating a gradient representation of the image, testing the gradient representation for illumination related characteristics, and modifying the gradient representation as a function of testing results to provide an illumination-invariant gradient representation of the image. As a feature of the second exemplary embodiment, the illumination related characteristics include similarity of direction and neutral color saturation aspects of the gradient representation.

In a third exemplary embodiment of the present invention, a computer system is provided. The computer system comprises a CPU and a memory storing an image file. Pursuant to a feature of the present invention, the CPU is arranged and configured to execute a routine to generate a gradient representation of an image depicted in the image file, and to normalize the gradient representation to generate an illumination-invariant gradient representation of the image.

In a fourth exemplary embodiment of the present invention, a computer system is provided. The computer system comprises a CPU and a memory storing an image file. Pursuant to a feature of the present invention, the CPU is arranged and configured to execute a routine to generate a gradient representation of an image depicted in the image file, to test the gradient representation for illumination related characteristics, and to modify the gradient representation as a function of testing results to provide an illumination-invariant gradient representation of the image.

In accordance with yet further embodiments of the present invention, computer systems are provided, which include one or more computers configured (e.g., programmed) to perform the methods described above. In accordance with other embodiments of the present invention, computer readable media are provided which have stored thereon computer executable process steps operable to control a computer(s) to implement the embodiments described above. The automated, computerized methods can be performed by a digital computer, analog computer, optical sensor, state machine, sequencer or any device or apparatus that can be designed or programmed to carry out the steps of the methods of the present invention.

### BRIEF DESCRIPTION OF THE DRAWINGS

FIG. 1 is a block diagram of a computer system arranged and configured to perform operations related to images.

FIG. 2 shows an n×m pixel array image file for an image stored in the computer system of FIG. 1.

FIG. 3 shows a Sobel filter arrangement for generating a gradient representation of an image

FIG. 4 illustrates an example of a convolution of image values with a Sobel filter in a gradient generation.

FIG. 5 is a flow chart for generating a gradient representation of an image that solely reflects material edges of objects, according to a feature of the present invention.

### DETAILED DESCRIPTION OF THE PREFERRED EMBODIMENTS

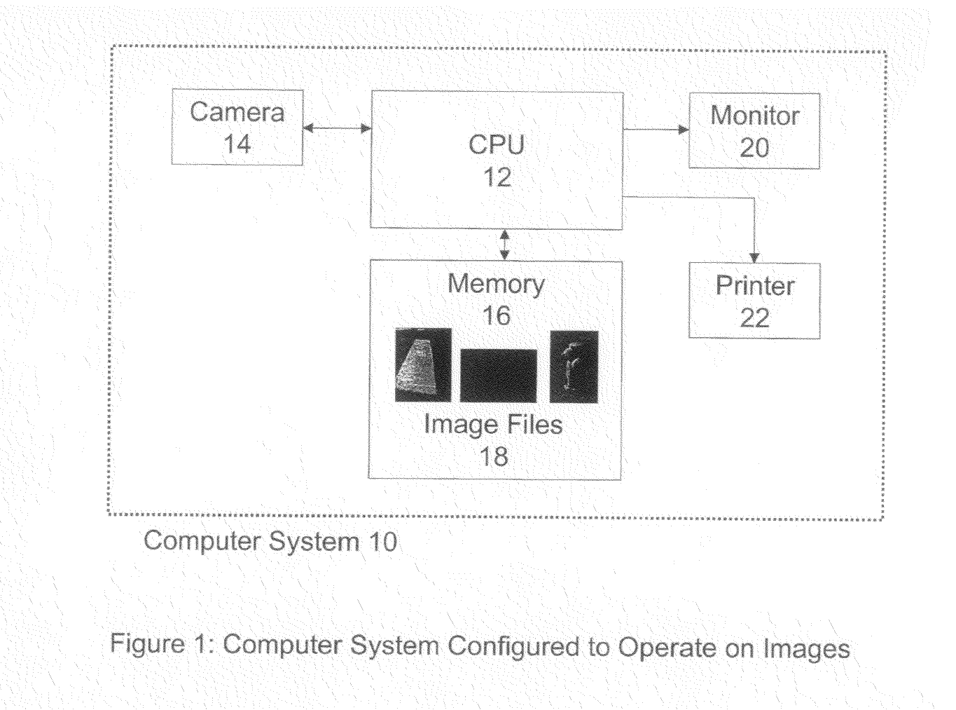

Referring now to the drawings, and initially to FIG. 1, there is shown a block diagram of a computer system 10 arranged and configured to perform operations related to images. A CPU 12 is coupled to a device such as, for example, a digital camera 14 via, for example, a USB port. The digital camera 14 operates to download images stored locally on the camera 14, to the CPU 12. The CPU 12 stores the downloaded images in a memory 16 as image files 18. The image files 18 can be accessed by the CPU 12 for display on a monitor 20, or for print out on a printer 22.

Alternatively, the CPU 12 can be implemented as a microprocessor embedded in a device such as, for example, the digital camera 14 or a robot. The CPU 12 can also be equipped with a real time operating system for real time operations related to images, in connection with, for example, a robotic operation or an interactive operation with a user.

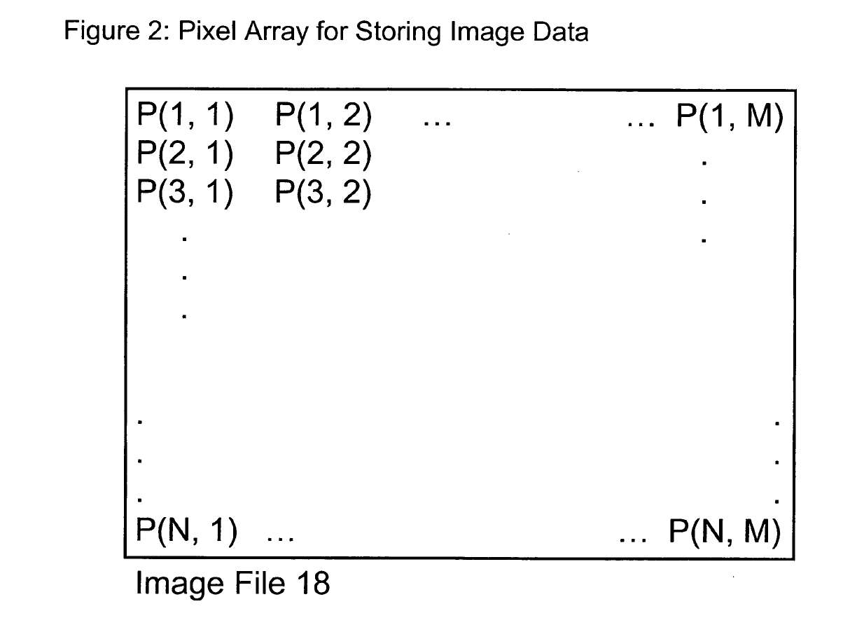

As shown in FIG. 2, each image file 18 comprises an n×m pixel array. Each pixel, p, is a picture element corresponding to a discrete portion of the overall image. All of the pixels together define the image represented by the image file 18. Each pixel comprises digital values corresponding to a set of color bands, for example, red, green and blue color components (RGB) of the picture element. The present invention is applicable to any multi-band image, where each band corresponds to a piece of the electromagnetic spectrum. The pixel array includes n rows of m columns each, starting with the pixel p (1,1) and ending with the pixel p(n, m). When displaying or printing an image, the CPU 12 retrieves the corresponding image file 18 from the memory 16, and operates the monitor 20 or printer 22, as the case may be, as a function of the digital values of the pixels in the image file 18, as is generally known.

In an image operation, the CPU 12 operates to analyze the RGB values of the pixels of a stored image file 18 to achieve various objectives, such as, for example, object recognition. A fundamental observation underlying a basic discovery of the present invention, is that an image comprises two components, material and illumination. All changes in an image are caused by one or the other of these components. A method for detecting of one of these components, for example, illumination, provides a mechanism for distinguishing material or object geometry, such as object edges, from illumination and shadow boundaries.

As noted above, gradient processing provides an advantageous representation of an image for computer processing of an image. In one known technique for generating a gradient representation of an image, a Sobel filter is used in a convolution of pixel values of an image file 18. Sobel filters can comprise pixel arrays of, for example, 3×3, 5×5 or 7×7. Other known techniques can be used to generate gradient representations, see, for example, Michael D. Heath, Sudeep Sarkar, Thomas Sanocki, Kevin W. Bowyer, “Robust Visual Method for Assessing the Relative Performance of Edge-Detection Algorithms,” IEEE Transactions on Pattern Analysis and Machine Intelligence, vol. 19, no. 12, pp. 1338-1359, December, 1997.

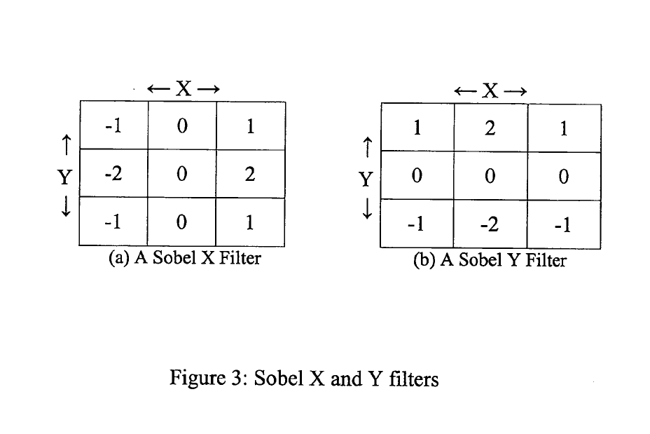

As shown in FIG. 3, a Sobel filter can comprise a set of 3×3 arrays of multiplication factors. A first Sobel filter (left in FIG. 3) is an X filter, to convolute the values of a pixel in the X direction of a color space, such as the RGB space used for the pixel values of an image file 18. As shown in the X filter, the multiplication factors are 0 in the middle column, in the Y direction, where the X value remains the same relative to the central box of the array. Each box surrounding the central box contains a multiplication factor from −2 to +2. A similar array is shown on the right of FIG. 3, to provide a Y filter with the middle row containing multiplication factors of 0, where the Y value remains the same relative to the central box of the array.

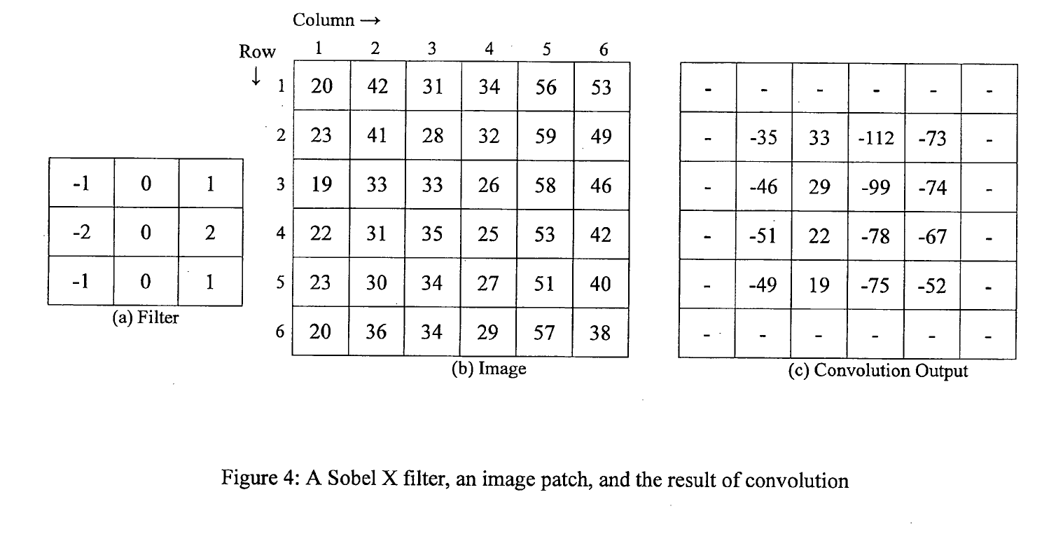

FIG. 4 shows an example of a convolution of image values with a Sobel filter ((a) in FIG. 4) in a gradient generation. For simplification of the description, the example shows convolution of one pixel value, for example, the red value of the RGB values corresponding to each pixel, over a 6×6 row and column pixel array of the image file 18 ((b) in FIG. 4). Moreover, the example shows convolution by an X filter. In a full filtering operation, convolution will occur using both the X filter and the Y filter, applied to each of the red, green and blue components of each pixel value, providing X and Y gradient values for each of the red, green and blue components of each pixel over the full image file 18. The right most array of FIG. 4 (array labeled (c)) shows the convolution output.

In the known process for convolution, the X filter is used as a mask that is inverted and placed over a current pixel, with the central box of the mask over the current pixel. For explanation, refer to the red value of pixel p(2,2) which has a value of 41 in the six row and column example shown in FIG. 4. The red values of the surrounding pixels, clockwise from the upper left: (p(1,1)=20; p(1,2)=42; p(1,3)=31; p(2,3)=28; p(3,3)=33; p(3,2)=33, p(3,1)=19; p(2,1)=23, are each multiplied by the corresponding factor in the inverted filter mask. Thus, 20×1; 42×0; 31×−1; 28×−2; 33×−1; 33×0; 19×1; 23×2. This results in a sum of 20−31−56−33+19+46=−35, as shown in the convolution result for p(2,2).

When the Y value is also calculated in a similar manner, each of the magnitude and direction of the red value change relative to each pixel is determined. The filtering is continued in respect of each of the green and blue components of each pixel, for a full gradient representation of the image. However, both the magnitude and relative magnitude at each pixel location are affected by the illumination conditions at the time the image was recorded.

Pursuant to a feature of the present invention, an illumination invariant gradient is generated form the result of the gradient operation. The original result can be expressed by the formula (relative to the example described above):

R=I_{p(1,1)}−I_{p(1,3)}−2I_{p(2,3)}−I_{p(3,3)}+I_{p(3,1)}+2I_{p(2,1)},

where I_{p(i,j)} represents the image value at the pixel designated by the i and j references, for example, p(1,1).

According to a simple reflection model, each image value for the pixels used to generate the gradient value, as expressed in the above formula for the result R, can be expressed as I_{p(i,j)}=M_{p(i,j)}*L, where M_{p(i,j)} is the material color depicted by the designated pixel and L is the illumination at the pixel at the time the image was recorded. Since the filter covers a relatively small region of the overall image, it is assumed that L is constant over all the pixels covered by the filter mask. It should be understood that each of I_{p(i,j)}, M_{p(i,j)} and L is a vector value with as many elements as there are components in the pixel values, in our example, three elements or color channels corresponding to the RGB space.

Thus, the original gradient result R can be expressed as

R=M_{p(1,1)}*L−M_{p(1,3)}*L−2M_{p(2,3)}*L−M_{p(3,3)}*L+M_{p(3,1)}*L+2M_{p(2,1)}*L.

An illumination invariant gradient result R′ is obtained by normalizing the R value, that is dividing the result R, by the average color of the pixels corresponding to the non-zero values of the filter.

R′=M_{p(1,1)}*L−M_{p(1,3)}*L−2M_{p(2,3)}*L−M_{p(3,3)}*L+M_{p(3,1)}*L+2M_{p(2,1)}*L/I_{p(1,1)}+I_{p(1,3)}+I_{p(2,3)}+I_{p(3,3)}+I_{p(3,1)}+I_{p(2,1)}.

Expressing the I_{p(i,j)} values in the above formula for R′ with the corresponding M and L values, as per the equation I_{p(i,j)}=M_{p(i,j)}*L,

R′=M_{p(1,1)}*L−M_{p(1,3)}*L−2M_{p(2,3)}*L−M_{p(3,3)}*L+M_{p(3,1)}*L+2M_{p(2,1)}*L/M_{p(1,1)}*L+M_{p(1,3)}*L+M_{p(2,3)}*L+M_{p(3,3)}*L+M_{p(3,1)}*L+M_{p(2,1)}*L.

In the M and L value expression of the result R′, all of the L values cancel out, leaving an equation for the value of R′ expressed solely in terms of material color values:

R′=M_{p(1,1)}−M_{p(1,3)}−2M_{p(2,3)}−M_{p(3,3)}+M_{p(3,1)}+2M_{p(2,1)}/M_{p(1,1)}+M_{p(1,3)}+M_{p(2,3)}+M_{p(3,3)}+M_{p(3,1)}+M_{p(2,1)}.

Thus, the above equations establish that the value R′ is a fully illumination-invariant gradient measure. However, while the above developed illumination-invariant gradient measure provides pixel values that are the same regardless of illumination conditions, the values still include gradient values caused by shadow edges themselves. The edges of shadows can appear in the same manner as the material edges of objects.

Pursuant to a feature of the present invention, the value R′ is further processed to eliminate gradient values that are caused by shadow edges, to provide gradient values at pixel locations that are derived solely on the basis of material properties of objects. Pixel color values are caused by the interaction between specular and body reflection properties of material objects in, for example, a scene photographed by the digital camera 14 and illumination flux present at the time the photograph was taken. The illumination flux comprises an ambient illuminant and an incident illuminant. The incident illuminant is light that causes a shadow and is found outside a shadow perimeter. The ambient illuminant is light present on both the bright and dark sides of a shadow, but is more perceptible within the dark region.

According to an aspect of the teachings of the present invention, the spectra of the ambient illuminant and the incident illuminant are different from one another, yet the difference is slight enough such that gradient direction between ambient and incident conditions can be considered to be neutral. Thus, if illumination is changing in a scene, but the material remains the same, the gradient direction between pixels from one measurement to the next should therefore also be neutral. That is, when an edge is due only to illumination change, the two sides of the boundary or edge should have different intensities, but similar colors.

Pursuant to a feature of the present invention, a color change direction, and saturation analysis is implemented to determine if a gradient representation at a particular pixel location is caused by a material change or illumination. Certain conditions, as will be described, indicated by the analysis, provide illumination related characteristics that can identify with a high degree of certainty that a gradient is not caused by illumination, and such identified gradients are retained in the gradient representation. Gradients that do not satisfy the certain conditions, are deleted from the representation, to in effect filter out the gradients likely to have been caused by illumination. The removal of gradients that do not satisfy the certain conditions may remove gradients that are in fact material changes. But a substantial number of material gradients remain in the representation, and, thus, the remaining gradients appear the same regardless of the illumination conditions at the time of recording of the image.

A gradient value at a pixel, the color of the gradient, indicates the amount by which the color is changing at the pixel location. For example, an R′ value for a particular pixel location, in an RGB space, can be indicted by (0.4, 0.9, 0.3). Thus, at the pixel location, the red color band is getting brighter by 0.4, the green by 0.9 and the blue by 0.3. This is the gradient magnitude at the pixel location. The gradient direction can also be determined relative to the particular pixel location. A reference line can extend directly to the right of the pixel location, and rotated counterclockwise, while measuring color change at neighboring pixels, relative to the particular pixel location, to determine the angle of direction in which color change gets maximally brighter. The maximum red color change of 0.4 may occur at, for example 45°, while the maximum green color change occurs at 235°, and the maximum blue color change occurs at 330°.

As noted above, the incident illuminant is light that causes a shadow and is found outside a shadow perimeter, while the ambient illuminant is light present on both the bright and dark sides of a shadow. Thus, a shadow boundary coincides with a diminishing amount of incident illuminant in the direction into the shadow, and a pure shadow boundary (over a single material color) must result in a corresponding lessening of intensity in all color bands, in our example, each of the RGB color channels. Consequently, the gradient directions of all color channels at an illumination boundary, must all be sufficiently similar. Accordingly, pixel locations with substantially different gradient directions among the color channels are considered to be caused by a material change, while pixel locations with sufficiently similar gradient directions may be caused by a either an illumination change or a material change.

Sufficiently similar can be defined in terms of a threshold value. All color channels must have a direction within the threshold of one another. Thus, for example, the direction of the red color channel must be within the threshold value relative to the direction of the green color. A convenient threshold is 90°, because in accordance with known properties of linear algebra, when a dot product between two vectors is positive, the two vectors are within 90° of one another. Conversely, when the dot product between two vectors is negative, the two vectors are not within 90° of one another. Each gradient direction can be expressed as a vector, and the dot products easily determined to verify similarity of direction.

In our example, the gradient directions for the red, green and blue components vary from 45°, to 235°, to 330°. Thus, the pixel under examination is due to a material change since, for example, the color red is increasing maximally in the direction of 45°, 170° away from the 235° direction of the color green, while the 235° direction is 95° away from the 330° direction of the color blue. All such pixel locations are kept in the gradient representation, while all pixel locations having color channels with sufficiently similar gradient directions (within 90° of one another) are subject to a test for color saturation, to determine if the gradient is due to a material change or an illumination change.

A gradient value is essentially a measure of color differences among pixel locations. In the exemplary embodiment utilizing a Sobel filter, the gradient value is a subtraction of two colors averaged over a small area of the image (in our example, a 3×3 array). In the case of a gradient caused by different illumination over the same material (the type of gradient to be filtered out of the gradient representation of an image according to a feature of the present invention), the gradient measurement can be expressed by the equation: (M*L₁−M*L₂)/(M*L₁+M*L₂)=(L₁−L₂)/(L₁+L₂). The gradient measure of the equation represents the spectral difference of the two light values L₁ and L₂ when the gradient corresponds to a simple illumination change over a single material. In such a case, the magnitudes of the gradient in each color channel should be substantially equal, and thus neutral. A determination of the saturation of the gradient color corresponding to a pixel location showing sufficiently similar gradient directions can be used to measure how neutral or non-neutral the respective color is at the pixel location.

Saturation can be measured by any known technique, such as, for example, the relationship of (max−min)/max. A saturation determination for a gradient at a particular pixel location can be compared to a threshold value. If the color saturation at a particular pixel location showing sufficiently similar gradient directions, is more saturated than the threshold value, the pixel location is considered a gradient representation based upon a material change. If it is the same as or less than the saturation of the threshold value, the particular pixel location showing sufficiently similar gradient directions is considered a gradient representation based upon an illumination change, and removed from the gradient representation for the image. The threshold value can be based upon an empirical or experimentally measured saturation of an illumination relevant to the illumination conditions expected to be incurred during the recording of images. For example, when the images are to be recorded outdoors during daylight hours, (L₁−L₂)/(L₁+L₂) values can correspond to sunlight and skylight near sunset, respectively. Such values represent a maximal difference in spectra likely to be expected in natural illumination.

Upon completion of tests for similarity of gradient direction and color saturation, all gradient values representing illumination boundaries have been filtered out, and the remaining gradient representations, according to a feature of the present invention, include only gradient values corresponding to material change. As noted above, the removal of gradients that show both a similarity of direction and neutral saturation may remove some gradients that are in fact material changes. However, the material gradients that are removed are always removed, irrespective of illumination conditions, and a substantial number of material gradients remain in the representation, with the remaining gradients appearing the same regardless of the illumination conditions at the time of recording of the image.

A gradient representation of an image without gradients associated with illumination changes can then be used in such computer related image processes as object recognition, object detection or any other image analysis typically performed using gradient information. For example, a SIFT object recognition system collects information about the distribution of gradient directions at key points in an image, for an object recognition analysis. When illumination edges occur, the distribution of gradient directions around key points can be altered, thereby affecting the accuracy of the object detection. Implementation of a SIFT system utilizing gradient information with illumination related gradients filtered out, according to features of the present invention, results in a more robust object recognition performance.

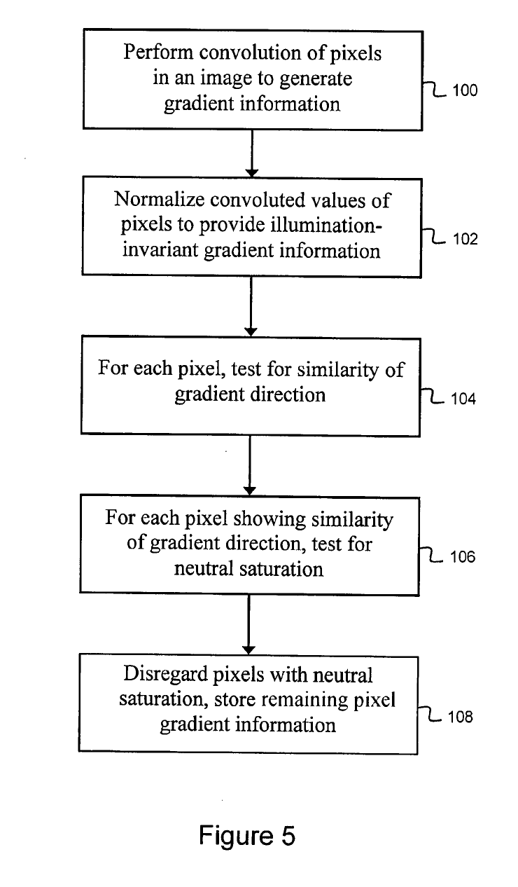

Referring now to FIG. 5 there is shown a flow chart for generating a gradient representation of an image that solely reflects material aspects, such as object edges, according to a feature of the present invention. In step 100, the CPU 12 performs a convolution of pixel values in a subject image of an image file 18, for example using a Sobel filter, as described above, to generate gradient information for the image. In step 102, the CPU 12 normalizes the gradient information to provide illumination-invariant gradient information. The normalizing operation can be implemented by dividing the Sobel filter result, by the average color of the pixels corresponding to the non-zero values of the Sobel filter.

In step 104, at each pixel location in the image file 18, the CPU 12 tests the gradient information for similarity of direction in each color channel, for example RGB color channels. In step 106, the CPU 12 further tests all pixel locations showing sufficiently similar gradient directions, for neutral saturation. In step 108, the CPU 12 disregards pixel locations with neutral saturation and stores the remaining pixel gradient information to provide an illumination-invariant gradient representation of the image file 18, with all gradient information corresponding to material aspects of the image.

In the described exemplary embodiments, Sobel filters were used to generate the gradient information. However, any known method for generating gradient information, such as Difference of Gaussians, can be implemented.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. An automated, computerized method for processing an image, comprising the steps of:
generating a gradient representation of the image; and
normalizing the gradient representation to generate an illumination-invariant gradient representation of the image.

2. The method of claim 1, wherein the image comprises an array of pixels.

3. The method of claim 2 wherein the step of generating a gradient representation of the image is carried out by convoluting each pixel of the array of pixels as a function of a Sobel filter.

4. The method of claim 3 wherein the step of normalizing the gradient representation to generate an illumination-invariant gradient representation of the image is carried out by dividing the convoluted value of each pixel by an average color value of pixels covered by a Sobel filter.

5. An automated, computerized method for processing an image, comprising the steps of:
generating a gradient representation of the image;
testing the gradient representation for illumination related characteristics; and
modifying the gradient representation as a function of testing results to provide an illumination-invariant gradient representation of the image.

6. The method of claim 5, wherein the image comprises an array of pixels, and the step of generating a gradient representation of the image is carried out by convoluting each pixel of the array of pixels as a function of a Sobel filter.

7. The method of claim 6, wherein the step of testing the gradient representation for illumination related characteristics is carried out by testing the convoluted values of the pixels of the array, for illumination related characteristics.

8. The method of claim 7, wherein the illumination related characteristics include gradient direction and color saturation.

9. The method of claim 8, wherein the step of modifying the gradient representation as a function of testing results is carried out by deleting convoluted pixels having illumination related characteristics from the gradient representation of the image.

10. The method of claim 5 comprising the further step of normalizing gradient representation of the image, prior to performance of the testing step.

11. The method of claim 5 wherein the illumination related characteristics include similarity of direction and neutral color saturation aspects of the gradient representation.

12. The method of claim 5, wherein the image comprises an array of pixels.

13. The method of claim 12 wherein the step of generating a gradient representation of the image is carried out by generating a gradient value for each pixel of the array.

14. The method of claim 13 wherein the step of testing the gradient representation for illumination related characteristics is carried out by testing the gradient value of each pixel for a similarity of direction aspect of the gradient representation.

15. The method of claim 14 wherein the similarity of direction aspect of the gradient representation comprises a threshold angle of separation.

16. The method of claim 15 wherein the threshold angle of separation is 90°.

17. The method of claim 14 comprising the further step of testing pixels showing a similarity of direction aspect for a neutral color saturation condition.

18. The method of claim 17 wherein the step of testing pixels showing a similarity of direction for a neutral color saturation condition is carried out by comparing a saturation of each pixel showing a similarity of direction aspect to a threshold saturation level.

19. A computer system which comprises:
a CPU; and
a memory storing an image file;
the CPU arranged and configured to execute a routine to generate a gradient representation of an image depicted in the image file, and to normalize the gradient representation to generate an illumination-invariant gradient representation of the image.

20. A computer system which comprises:
a CPU; and
a memory storing an image file;
the CPU arranged and configured to execute a routine to generate a gradient representation of an image depicted in the image file, to test the gradient representation for illumination related characteristics, and to modify the gradient representation as a function of testing results to provide an illumination-invariant gradient representation of the image.
